(19) United States
(12) Patent Application Publication
(10) Pub. No.: US 2010/0172501 A1
(43) Pub. Date: Jul. 8, 2010

(54) Secure key system

(76) Inventors: WeiCheng Tian, ShangHai (CN); Yi Dong, Shanghai (CN)

Correspondence Address: DAVID AND RAYMOND PATENT FIRM, 108 N. YNEZ AVE., SUITE 128, MONTEREY PARK, CA, 91754, US

(21) Appl. No.: 12/319,467

(22) Filed: Jan. 6, 2009

(51) Int. Cl. H04L 9/00

(52) U.S. Cl. 380/277

(57) ABSTRACT

A secure key system includes a key provider for partitioning and converting a private key into a plurality of key components, and a plurality of key holders storing the key components therein respectively for enhancing a security level of the private key, wherein all of the key holders are united to synthesize back the private key from the key components in order for completing a confirmation process so as to ensure the confirmation process being verified by all of the key holders.

### BACKGROUND OF THE PRESENT INVENTION

1. Field of Invention

The present invention relates to a key security system, and more particularly to a secure key system, which can securely divide the encrypted information into a plurality of encrypted key components to be stored into a plurality of transport cards, such that the secure key system guarantees the safety of key storage for the encrypted information and ensures the transport card with the encrypted information not being hacked.

2. Description of Related Arts

Key management is one of key issues in the field of information encryption. Accordingly, the key management generally consists of public key and private key. If the private key is deciphered, the information encrypted with the key management will be disclosed. In other words, the first issue of protecting the encrypted information through the key management is how to safely generate the private key. The second issue is how to safely store the private key in a key device. The third issue is how to protect the private key in the key device without being hacked.

### SUMMARY OF THE PRESENT INVENTION

A main object of the present invention is to provide a secure key system which guarantees the safety of key storage for the encrypted information and ensures the transport card with the encrypted information not being hacked.

The present invention is a key system by using a smart card as a security module, wherein the private key is decentralized and stored to the transport cards. Accordingly, the encryption algorithm, XOR encryption, and random number are used for the private key exporting and synthesizing processes. In addition, during the use of the private key, passwords, including PINm and PINu, must be inputted in order for the access of the private key. The transport cards are held by authorized people respectively. Therefore, the above mentioned preservations enhance the high security level of the secure key system of the present invention for preventing the private key from being deciphered.

Accordingly, in order to accomplish the above objects, the present invention provides a secure key system comprising a key provider and a plurality of key holders.

The key provider, which is embodied as the seed card, is arranged for partitioning a private key into a plurality of key components, wherein each of the key components is converted and encrypted by the key provider.

The key holders, which are the transport cards, are arranged for storing the key components therein respectively for enhancing a security level of the private key, wherein all of the key holders are united to synthesize back the private key from the key components in order for completing the confirmation process so as to ensure the confirmation process being verified by all of the key holders.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a secure key system according to a preferred embodiment of the present invention, illustrating the key pair generation system to the seed card and the transport cards.

FIG. 2 is a schematic view of the secure key system according to the above preferred embodiment of the present invention, illustrating the use of the transport card to synthesize the private key.

FIG. 3 is a schematic view of the seed card of the secure key system according to the above preferred embodiment of the present invention.

FIG. 4 is a schematic view of the transport card of the secure key system according to the above preferred embodiment of the present invention.

FIG. 5 is a schematic view of the target card as one of the transport cards of the secure key system according to the above preferred embodiment of the present invention.

FIG. 6 is a flow chart illustrating the key exporting from the seed card to the transport cards according to the above preferred embodiment of the present invention.

FIG. 7 is a flow chart illustrating the key synthesizing process according to the above preferred embodiment of the present invention.

FIG. 8 is a flow chart illustrating the key signature according to the above preferred embodiment of the present invention.

### DETAILED DESCRIPTION OF THE PREFERRED EMBODIMENT

The secure key system of the present invention utilizes the algorithm of RSA with 2048 bit, which consists of a public key and a private key. The secure key system for completing a confirmation process comprises a key provider for partitioning the private key generated by a key generation system and a plurality of key holder for holding the private key which is encrypted and decentralized from the key provider. Accordingly, all of the key holders are united to synthesize back the private key from the key components in order for completing the confirmation process so as to ensure the confirmation process being verified by all of the key holders.

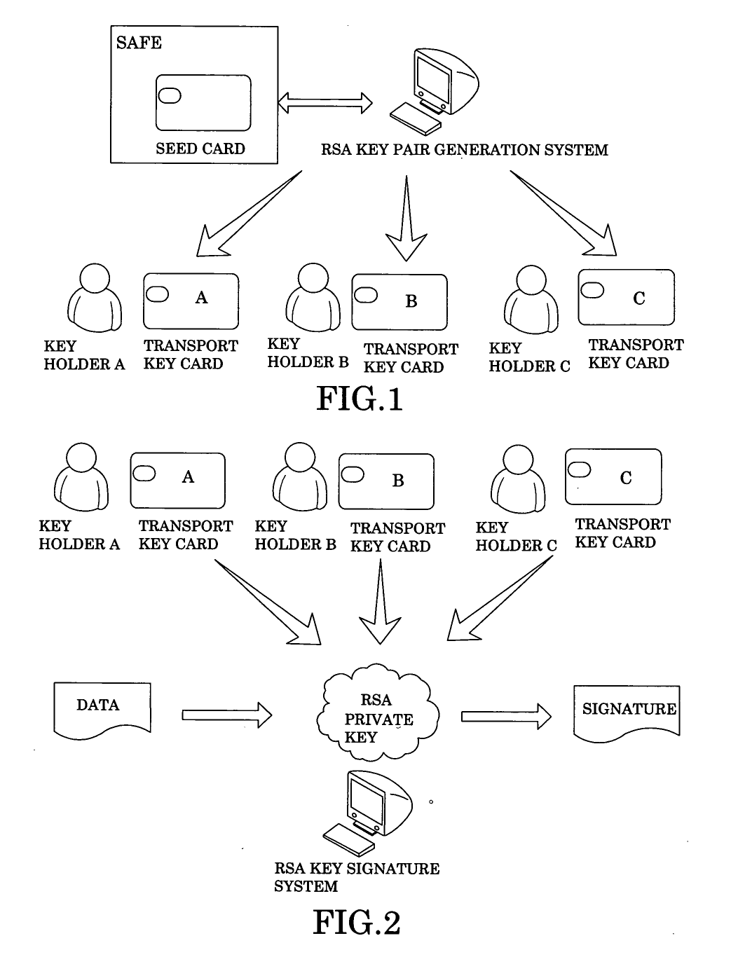

The secure key system uses a smart card which comprises a seed card as the key provider and at least two transport cards as the key holders. Preferably, there are two to five transport cards being used. According to the preferred embodiment, three transport cards are used. The private key is saved in the seed card. In addition, through the seed card, the private key is divided into three key components as the puzzles of the private key and saved into the three transport cards respectively, wherein the three transport cards are held by different authorized persons as the card holders, as shown in FIG. 1. In other words, the seed card is used to transitionally save the private key and to initialize the key components to be saved in the key holders respectively. It is worth mentioning that the key provider and the key holders can be an electronic communicating device adapted to partition and encrypt the key components and to synthesize back the key components to the private key. Preferably, the key holders are the transport cards that the authorized persons can physically hold the transport cards in a security manner.

After the verification of each of the card holders, the key components in the transport cards can be synthesized back to form the private key. In other words, the private key will be achieved only, as shown in FIG. 2, when all the card holders represent the transport cards in order for performing the signature process as one example of the confirmation process. It is worth mentioning that during the synthesizing process of the private key, the private key will not be exported to any external device. The private key will only saved in a safety region of the smart card.

According to the preferred embodiment, the seed card and the transport cards of the smart card are JavaCard. The secure key system has a specific processor for RSA computation and specific security mechanism for key storage. Therefore, the private key can be saved in the smart card in a security manner.

Accordingly, each of the smart cards, including the seed card and the transport cards, has a serial number (SN) for regional identification. In addition, each smart card further has a set of Personal Identification Numbers (PIN), wherein the PIN consists of Personal Identification Number for Management (PINm) and Personal Identification Number for User (PINu). For exporting the private key and signature processing, the PINm and PINu must be inputted. Each of the smart cards also has its paired key, i.e. Transport Public Key (TKp) and Transport Private Key (TKs), and the security protection for corresponding data transmission.

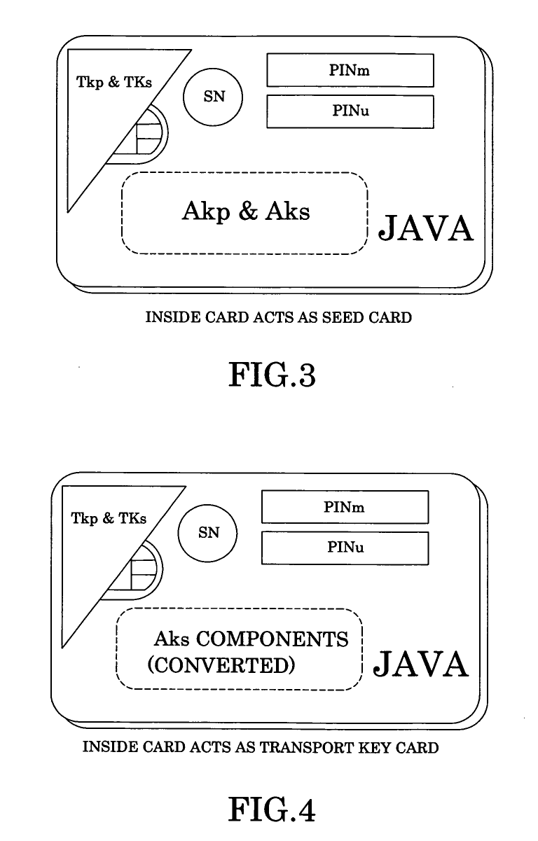

In particularly, after the generation of the private key through the key generation system, the private key is saved in the seed card. The seed card has a paired key, i.e. Application Public Key (AKp) and Application Private Key (AKs), wherein AKp and AKs are encrypted through RSA process, as shown in FIG. 3. In addition, Aks of the private key is used for number signature process while the public key submission is used for signature verification.

As shown in FIG. 4, each of the transport cards contains an encrypted key component as a part of the private key. The secure key system, which is also a key encryption signature system, will designate one of the transport cards as a target card for synthesizing the private key. After the signature process, the synthesized private key in the target card will be destroyed.

In order to generate the key through the key generation system, the private key has the AKs for the private key and AKp for the public key. The AKp of the public key is saved in the data or information. The AKs of the private key is saved in the safety region of the smart card, wherein the AKs is divided into a plurality of key components, as the AKs components. Preferably five key components are used in this embodiment for the AKs, i.e. p, q, dp, dq, and pq. It is worth mentioning that the key components of the private key can only be accessed after the verification, wherein they cannot be read or exported.

After the private key is generated, the seed card can be destroyed immediately or can be kept by the authorized person in a safety manner.

In particularly, the private key is generated through a key generation software, as an example, wherein the key generation software is a public software that it can be downloaded or purchased by a software provider.

However, the key generation system for the smart card, the data transmission of the smart card, and the use of the smart card are controlled and processed by a smart card software. The smart card software is private and secure.

Accordingly, the private key is generated and saved in the seed card through the smart card software. The private key is generated in responsive to AKp and AKs of the paired key. Then, the seed card will transmit and decentralize the AKs into different key components, i.e. p, q, dp, dq, and pq. It is worth mentioning that AKp can be disclosed to the public. However, AKs cannot be disclosed to the public, wherein AKs is saved into two to five different transport cards.

Preferably, five different transport cards are used for saving five key components of AKs respectively. It is appreciated that two or more transport cards can also be used for saving the key components of AKs. It would be nonsense to save all the key components of AKs into one transport card.

It is worth mentioning that the key generation process for generating the key is not the subject matter of the present invention because there are many existing processes adapted to generate the key. However, how to securely save the key and how to protect the key are the subject matters of the present invention in order to prevent the leak of the key after the key is generated.

The key components of the private key to be exported to the transport cards in responsive to the key generation system depend on the number of the transport cards. TKp of the transport card is used for data transmission in a secure manner so as to verify the legality of the imported date to the transport card.

Accordingly, the export of the private key must require a random number so that the private key cannot be duplicated or reproduced. Every time after the AKs is exported to the transport card, the random number will be renewed.

The export of the key components of the private key is used by the algorithm of XOR (⊕), wherein the five key components of the private key and the random number are also generated in the seed card.

The conversion of the private key is used for linking one of the key components with the rest key components. For safety purpose, the random number is used during the conversion so as to ensure the different conversion values being formed for every conversion.

Accordingly, the following conversion process is illustrated.

H=p⊕q⊕dp⊕dq⊕pq⊕RND

CP (converted component p)=p⊕H;

CQ (converted component q)=q⊕H;

CDP (converted component dp)=dp⊕H;

CDQ (converted component dq)=dq⊕H;

CPQ (converted component pq)=pq⊕H;

CRND (converted component RND)=RND⊕H;

It is worth mentioning that the date imported into each of the transport cards must be encrypted as CP, CQ, CDP, CDQ, CPQ, and CRND. In addition, the key components of the private key after conversion are saved in the safety regions of the different transport cards and are unable to be read directly.

In order to synthesize the private key from the key components, every transport cards must be utilized. Before the use of the transport card, the respective card holder must input PINm of the corresponding transport card.

For safety purpose, the synthesized private key will be saved in one of the transport card, i.e. the target card. In other words, one of the transport cards must be designated as the target card as it is mentioned above. Preferably, all the transport cards have the same priority.

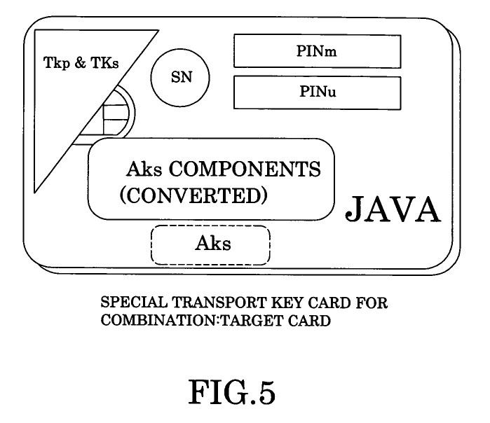

TKp at the target card ensures the data transmission to be secured and confirmed. In addition, the encrypted TKp at the target card is not part of the private key but is the key component of the private key after conversion. The key components of the private key are converted from the seed card and are exported to the transport cards. Therefore, the synthesized private key will be formed at the target card, as shown in FIG. 5.

After the signature process is completed, AKs of the private key in the target card will be erased or destroyed immediately. All the transport cards will then be reset to the original setting. Therefore, all the transport cards will be ready for the next signature process.

In order to convert the key components of the private key with the true value, the algorithm of XOR (⊕) is used as the following.

If H=CP⊕CQ⊕CDP⊕CDQ⊕CPQ⊕CRND; then:

p=CP⊕H;

q=CQ⊕H;

dp=CDP⊕H;

dq=CDQ⊕H;

pq=CPQ⊕H;

The key components of the private key will be completed by the reduction process in the target card.

The synthesizing process of the private key is illustrated as follows. Though the computation, CP, CQ, CDP, CDQ, and CPQ in the transport cards will be converted to p, q, dp, dq, and pq respectively. In addition, p, q, dp, dq, and pq will be saved in the target card.

AKs of the private key, including p, q, dp, dq, and pq, are saved in the target card to synthesize the private key thereat. Once the private key is accessed, i.e. once the signature process is completed, the private key will be destroyed by the software.

After the private key is used, all the transport cards will be reset back to the original setting. In other words, each transport card will contain the same setting of the key component.

The synthesizing process is repeatable. In other words, in order to complete the next signature process, all the transport cards must be re-used for synthesizing the private key.

The private key is formed by the synthesizing process through the algorithm of RSA, XOR, and random number to enhance the security level of the private key.

After the private key is generated at the seed card, the key components of the private key are exported to the transport cards respectively. Then, the seed card can be destroyed. If all the seed card and the transport cards are destroyed, the private key will be correspondingly lost.

Accordingly, the key encryption method for completing the confirmation process, comprises the following steps.

(1) Partition the private key into a plurality of key components.

(2) Convert the key components.

(3) After the key components are converted, export the key components into the key holders respectively for enhancing the security level of the private key.

(4) Synthesize back the private key by uniting the key components in the key holders in order for completing the confirmation process so as to ensure the confirmation process being verified by all of the key holders.

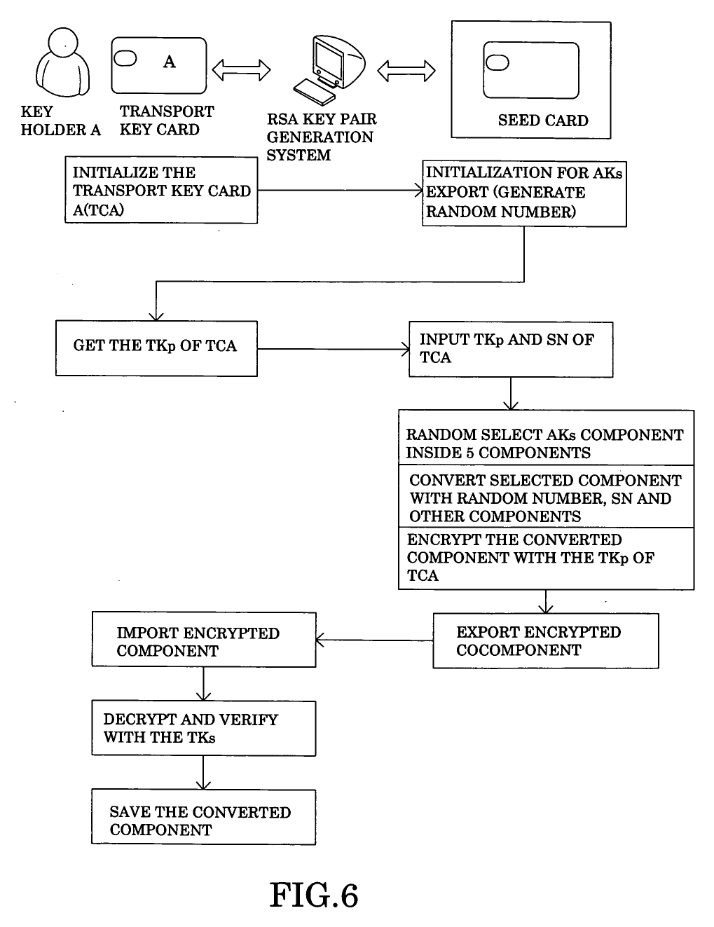

Accordingly, the steps (1) and (2) are the key export from the seed card to the transport cards. FIG. 6 illustrates flow diagram of the key exporting to the transport cards. As shown in FIG. 6, the seed card is arranged to initialize the transport card, as illustrated as the transport card A (TCA), wherein the seed card will generate the random number for the initialization of the AKs export. Meanwhile, the seed card will get the Transport Public Key (TKp) and Transport Private Key (TKs) as well as its serial number (SN). Accordingly, the seed card will get the TKp of the transport card A (TCA). In other words, by inputting the TKP and SN of the transport card A (TCA), the seed card will automatically identify the transport card A (TCA) to export the key components thereto.

In the step (1), the method of the present invention further comprises a step of selecting the number of the key components to be partitioned from the private key. Accordingly, the number of said key components correspondingly matches with the number of said key holders. When five transport cards are selected as in this embodiment, five key components are correspondingly formed. Once the number of the key components is selected, the seed card will convert all the key components with the random number, serial number (SN), and other corresponding components, as shown in the step (2). After the conversion in the step (2), the method further comprises a step of encrypting the key components after the key components are converted and before the key components are exported to the key holders respectively. In other words, the seed card will encrypt the converted components with the TKp of transport card A (TCA). Once the encrypted components are completed, the encrypted components are ready to export to the transport card A (TCA).

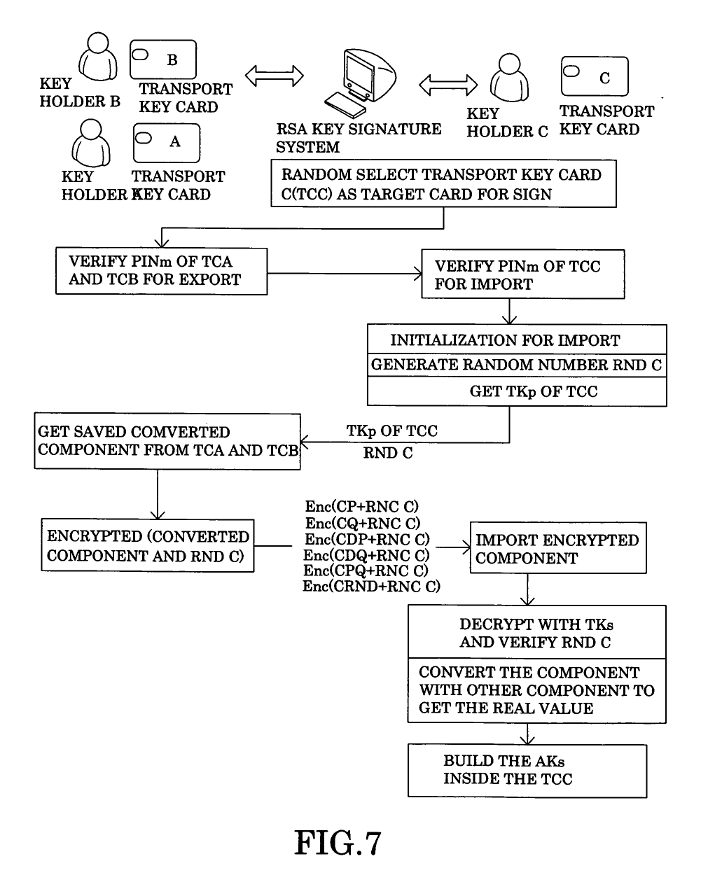

As shown in FIG. 7, the transport card C (TCC) is designated as the target card. It is worth mentioning that the target card can be designated by the operator or can be randomly picked by the seed card. Accordingly, when the transport card C (TCC) is utilized for synthesizing the private key, PINm of transport card A (TCC) and transport card B (TCB) are verified for export thereto. Meanwhile, PINm of transport card C (TCC) is also verified for import from the seed card. Once the steps of initialization for import of the transport card C (TCC) and generation of random number RND_C for the transport card C (TCC), and obtain TKp of transport card C (TCC), all the converted components from the transport card A (TCA) and the transport card B (TCB) are saved in the transport card C (TCC). Then, TKs of the transport card A (TCA), the transport card B (TCB), and the transport card C (TCC) are decrypted and the random number RND_C is verified, all the key components are converted to get the real value of the private key. Then, AKs will be built inside the transport card C (TCC).

Accordingly, all the transport cards (TCA), (TCB), (TCC) have the same level of priority. Alternatively, each transport card can have different priority levels that the transport cards (TCA), (TCB), (TCC) must be united in a predetermined manner. For example, the transport card A (TCA) must be used firstly to get the corresponding key component and the transport card B (TCB) must be used secondly to get the corresponding key component. Lastly, the transport card C (TCC) will be used as the target to get all the key components from the transport card A (TCA), the transport card B (TCB), itself. Furthermore, a time setting can be selectively preset from the seed card to the transport cards. For example, all the transport cards must be united at the same time or within a predetermined time range in order to combine the key components from all the transport cards for completing the signature process. Otherwise, the synthesizing process of the private key from the key component will be failed for the signature process.

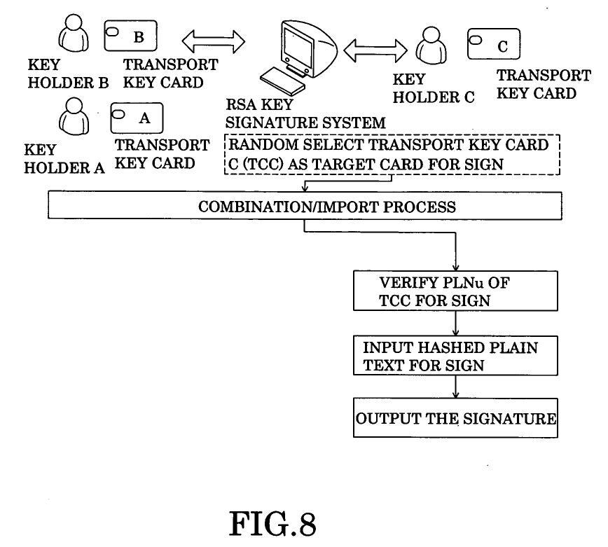

As shown in FIG. 8, the private key is synthesized in the transport card (TCC), i.e. the target card, through the combination/import process of the transport card A (TCA), the transport card B (TCB), and the transport card C (TCC). PINu of the transport card C (TCC) is required for verification in order to complete the signature process. Then, the user is able to input hashed plain text for sign and the signature will be output.

Accordingly, RSA algorithm is the most widely used public key algorithm, invented by Rivest, Shamir, and Adleman in 1977. it is based on a very simple number theory for the multiplication of two prime numbers to form a multiplication result. However, it is very difficult to decompose back to the prime numbers. Thus, multiplication result can be made public and can be used as the key encryption. However, the multiplication result can be simply restored back to the prime numbers. The multiplication result must be decrypted in order to form back the prime numbers. In other words, RSA algorithm provides a simple form to achieve a very reliable cryptosystem.

The following is an example of 2048 bit of RSA algorithm.

n is set as the key module, which is open to the public.

e is known as the key component of the public key, which is open to the public.

d is set as the key component of the private key, which is kept in secret.

(p, q, dp, dq, pq) is equivalent to d, which is kept in secret, wherein d is formed as the substitution of (p, q, dp, dq, pq) for enhancing the computing speed.

The key component of the present invention is d being partitioned from the private key.

```
{ /* Key number - 001 */
  { /* length in bits */
    2048
  },
  { /* Modulus - n */
  0xC3, 0x09, 0x58, 0x86, 0xAB, 0x6F, 0x65, 0x5A, 0xB7, 0x67, 0x71, 0x13, 0x0D, 0xAD, 0x79, 0x1C,
  0x4B, 0x07, 0x4A, 0xD6, 0x40, 0xB5, 0x58, 0x07, 0xBD, 0xFA, 0x8D, 0x15, 0x8D, 0x97, 0x27, 0xC5,
  0x0E, 0x6D, 0x88, 0x4D, 0xDE, 0x0C, 0xBB, 0x00, 0xC7, 0xD3, 0x95, 0xE8, 0x7F, 0x2F, 0x97, 0x65,
  0x4B, 0x39, 0xAC, 0x76, 0xDC, 0x2A, 0x27, 0x3D, 0xB5, 0x89, 0x96, 0xF7, 0x80, 0x38, 0x45, 0x15,
  0xB3, 0x4A, 0x0A, 0x25, 0xC4, 0x42, 0x64, 0xAA, 0x4D, 0x19, 0x32, 0xA3, 0x30, 0x17, 0x02, 0x00,
  0x5C, 0xB0, 0x78, 0xED, 0xD4, 0xEB, 0x95, 0x72, 0xA1, 0x0F, 0xA7, 0xB7, 0xAC, 0xF1, 0xB6, 0x9C,
  0xE2, 0x12, 0x21, 0x1A, 0x0D, 0x83, 0xC2, 0xE6, 0xA5, 0x3D, 0xEB, 0x6C, 0x28, 0x71, 0x06, 0xB5,
  0xD3, 0x2F, 0xC9, 0x84, 0x1D, 0xC9, 0x97, 0xD2, 0xDD, 0x48, 0xF4, 0x66, 0xE4, 0xD1, 0xD3, 0x67,
  0x9E, 0xEB, 0xDB, 0xB4, 0xBD, 0xD3, 0x2C, 0x1D, 0x62, 0x4D, 0x5D, 0x12, 0x93, 0xFB, 0xA7, 0x1B,
  0xE2, 0x64, 0xA0, 0x67, 0x74, 0x25, 0x8F, 0xD2, 0x57, 0x38, 0x0C, 0x1A, 0x44, 0xB2, 0xE1, 0x52,
  0x2F, 0xF4, 0x5E, 0xCE, 0x44, 0xD8, 0x71, 0x70, 0x07, 0x2B, 0x7A, 0xE0, 0xD6, 0x7B, 0x24, 0xA6,
  0x3A, 0x8A, 0x3F, 0x8D, 0x9E, 0x0B, 0xB6, 0x44, 0x10, 0xCC, 0xBA, 0xDB, 0x24, 0x8E, 0xFC, 0x1C,
  0x3C, 0x30, 0x30, 0xD0, 0x16, 0x33, 0xAC, 0x2D, 0x7C, 0xBB, 0x19, 0x77, 0x26, 0xD6, 0xE6, 0x29,
  0x24, 0xC6, 0xEC, 0xFB, 0x74, 0x18, 0x2B, 0x6B, 0x30, 0xD7, 0x3D, 0x02, 0x9B, 0x58, 0xEA, 0x47,
  0x5A, 0x68, 0x3F, 0xD1, 0x7E, 0x18, 0x55, 0x19, 0xF5, 0xFA, 0x99, 0x4C, 0x82, 0xD8, 0xAE, 0xA3,
  0xEC, 0x6C, 0xF9, 0x3C, 0x77, 0x45, 0xE7, 0xDE, 0x5C, 0x7D, 0xC1, 0x5B, 0x73, 0x5C, 0x62, 0x87
  },
  { /* Public Exponent - e */
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x00,
  0x00, 0x00, 0x00, 0x00, 0x00, 0x00, 0x00, 0x00, 0x00, 0x00, 0x00, 0x00, 0x00, 0x00, 0x00, 0x01
  },
  { /* Private Exponent - d */
  0x04, 0xD0, 0xAC, 0x40, 0xD6, 0xE6, 0xAF, 0x27, 0xE8, 0x33, 0x43, 0x95, 0x66, 0xD7, 0x0B, 0x90,
  0x69, 0x41, 0xCA, 0xD5, 0x33, 0x4F, 0xC6, 0xD6, 0x9A, 0x18, 0x1F, 0x77, 0x92, 0xC1, 0x52, 0x98,
  0x08, 0xDD, 0x27, 0x6A, 0x54, 0xBB, 0x17, 0xBA, 0xD3, 0x34, 0x24, 0x15, 0x53, 0x5E, 0x87, 0x6C,
  0x56, 0xC9, 0x1B, 0xBA, 0xEB, 0x80, 0x96, 0xEB, 0x6D, 0x19, 0xF2, 0x82, 0x35, 0xC6, 0x2D, 0xDE,
  0x75, 0x48, 0xB4, 0xAB, 0x6E, 0x06, 0xFD, 0x99, 0x3E, 0xC2, 0x0A, 0x80, 0x00, 0xE5, 0xF0, 0x84,
  0xB5, 0xC5, 0x1D, 0x97, 0x31, 0x94, 0x87, 0x62, 0x07, 0x1B, 0xED, 0xD6, 0x19, 0x0C, 0xF6, 0xA7,
  0x34, 0xE5, 0xA1, 0xAF, 0x94, 0xF9, 0xD5, 0xCB, 0xFF, 0xF4, 0x61, 0x65, 0x90, 0x32, 0x0A, 0x2A,
  0x5F, 0x06, 0x65, 0x01, 0x40, 0x03, 0x04, 0x1E, 0x8E, 0x9C, 0x08, 0x7C, 0xA9, 0xD5, 0x8C, 0x54,
  0x8D, 0x8C, 0x1B, 0x64, 0x9D, 0xD1, 0x0F, 0xEC, 0xD7, 0x08, 0x49, 0xD8, 0x08, 0x78, 0x50, 0x58,
  0xC1, 0xE7, 0x70, 0xE4, 0xA4, 0x39, 0x82, 0x73, 0x30, 0x43, 0x53, 0xA6, 0x12, 0x35, 0x69, 0xB9,
  0xB8, 0x6B, 0xBF, 0x97, 0x2D, 0xE0, 0x5F, 0x20, 0xBF, 0x3A, 0xF4, 0xBE, 0x5F, 0xBB, 0xC8, 0xDD,
  0x5D, 0xC9, 0xB5, 0x2F, 0x05, 0xDB, 0xB4, 0xFF, 0xF0, 0xBE, 0x2E, 0xE2, 0x6E, 0x4D, 0xD7, 0x9A,
  0x00, 0x79, 0xBB, 0xF9, 0xD8, 0xB7, 0x84, 0x94, 0x80, 0x1A, 0xC1, 0x46, 0xCE, 0x52, 0x76, 0xFF,
  0xBF, 0xC2, 0x88, 0xB2, 0x06, 0x95, 0xB4, 0x55, 0x3D, 0xD2, 0x2A, 0xB2, 0x15, 0x46, 0x3B, 0x36,
  0xD8, 0x06, 0xA0, 0x54, 0x9D, 0x89, 0x70, 0xF1, 0x07, 0x61, 0x48, 0x27, 0xE6, 0x01, 0xEE, 0x31,
  0xCA, 0xE4, 0xBB, 0xFB, 0x41, 0xC0, 0x56, 0x0C, 0x05, 0xBA, 0xB2, 0x9A, 0x22, 0xAD, 0x33, 0xB1
  },
{
  { /* Prime Factor - p */
  0xE6, 0x2B, 0x97, 0x49, 0xD9, 0xED, 0xAE, 0x85, 0x4B, 0xC1, 0xE0, 0x14, 0x4D, 0x41, 0x8B, 0xE1,
  0xA3, 0x50, 0x4E, 0xC6, 0xAB, 0x46, 0xA1, 0x5C, 0x72, 0xD3, 0x25, 0x6D, 0x77, 0xA4, 0x12, 0x94,
  0x48, 0x8D, 0x35, 0x95, 0xAA, 0x64, 0x8B, 0x40, 0x5E, 0x45, 0x49, 0x98, 0x4A, 0x6C, 0xC8, 0xBF,
  0x90, 0x4C, 0xBA, 0xED, 0x85, 0xA2, 0xF2, 0x42, 0xD5, 0xB5, 0xDE, 0x06, 0xCB, 0x80, 0x98, 0x61,
  0x50, 0x1D, 0x0E, 0x7B, 0xB9, 0xA7, 0x25, 0xD6, 0x03, 0x16, 0x9B, 0x88, 0x13, 0x1B, 0xA1, 0x01,
  0xB6, 0xD4, 0x5C, 0x39, 0xCF, 0xDA, 0x4E, 0xA2, 0x8B, 0x1C, 0xE8, 0x47, 0x98, 0x45, 0x4A, 0x7D,
  0xA8, 0xE9, 0x65, 0x11, 0xBF, 0x47, 0x57, 0x9D, 0xAA, 0x7F, 0xCD, 0xE2, 0x1C, 0x7F, 0x95, 0xE7,
  0x9F, 0x20, 0x0F, 0x43, 0x8A, 0x86, 0x10, 0x50, 0xCE, 0x77, 0xD8, 0x7C, 0x43, 0xA2, 0xEE, 0x23
  },
  { /* Prime Factor - q */
  0xD8, 0xEC, 0x6B, 0x8A, 0xA8, 0xC5, 0xE3, 0x2F, 0xD3, 0xE9, 0xF7, 0x16, 0x97, 0xAE, 0x44, 0xD3,
  0xFF, 0x20, 0x88, 0xAC, 0xF2, 0xEE, 0xF6, 0x93, 0xD7, 0x56, 0xAC, 0xDC, 0x9B, 0x24, 0x55, 0xFF,
  0xB3, 0x46, 0x3F, 0xDB, 0xA7, 0x7F, 0x72, 0xD3, 0x33, 0xDD, 0x05, 0x16, 0x79, 0x5C, 0x6C, 0xCE,
  0x83, 0x25, 0xF2, 0xA1, 0x83, 0x40, 0x20, 0x25, 0x07, 0x7D, 0x72, 0xB9, 0x94, 0x2F, 0xF2, 0x78,
  0x24, 0x20, 0x5A, 0x67, 0xDF, 0x05, 0xD5, 0x21, 0xE3, 0x73, 0x8A, 0xA9, 0x35, 0x12, 0xB7, 0x09,
  0xE1, 0x67, 0x42, 0x81, 0xD5, 0xA6, 0x24, 0x77, 0x4C, 0x44, 0xD9, 0x98, 0x86, 0x59, 0x7A, 0xE9,
  0x24, 0x21, 0x72, 0xC2, 0x9D, 0x43, 0xC8, 0x3F, 0xCD, 0xCD, 0xC6, 0x7B, 0x76, 0x32, 0x75, 0x7F,
  0x0E, 0x8F, 0xDC, 0x5D, 0xE9, 0x55, 0x3B, 0xCE, 0xC6, 0xDE, 0x4D, 0x5E, 0x31, 0x69, 0x56, 0x4D
  }
},
{
  { /* CRT Exponent -dp)*/
  0xA7, 0x4B, 0x33, 0xB1, 0x17, 0xD6, 0xEB, 0xAC, 0x32, 0xBD, 0xFD, 0xB2, 0x83, 0xDC, 0x8A, 0x61,
  0x3C, 0x24, 0x98, 0xBD, 0x49, 0xAC, 0x12, 0x88, 0x71, 0x65, 0x0A, 0xA5, 0x1F, 0xFA, 0x7F, 0x0E,
  0x8C, 0x15, 0x26, 0xC7, 0x5B, 0x8B, 0xAC, 0xB2, 0xE2, 0x52, 0x16, 0x05, 0xBC, 0xC2, 0x88, 0xBE,
  0xC3, 0x91, 0x21, 0xA4, 0x96, 0x27, 0x33, 0x52, 0x64, 0xA6, 0xC5, 0x73, 0xC6, 0xE1, 0xF6, 0xDF,
  0x74, 0x2D, 0x4A, 0x63, 0x9F, 0x32, 0xE0, 0x0B, 0x47, 0x3F, 0x5D, 0x58, 0x70, 0x1A, 0xFA, 0xD1,
  0x96, 0x23, 0x8F, 0xCC, 0xED, 0x48, 0x4D, 0x33, 0x53, 0x4D, 0x75, 0x7E, 0xE4, 0x2C, 0x28, 0xD2,
  0x60, 0xBD, 0x13, 0x1A, 0xED, 0x1E, 0x5B, 0x8E, 0x5B, 0x68, 0x7D, 0x2A, 0x45, 0x70, 0x6E, 0x72,
  0x65, 0x74, 0x15, 0xE4, 0x0F, 0x81, 0x15, 0xC6, 0xC5, 0xEA, 0xD1, 0xCC, 0xB0, 0x14, 0x72, 0x65
  },
  { /* CRT Exponent - dq*/
  0x51, 0x06, 0x25, 0xB9, 0x1A, 0x07, 0x28, 0x2F, 0xB2, 0x28, 0xBE, 0xD9, 0x1A, 0x78, 0xC6, 0x4E,
  0xA5, 0x09, 0xE2, 0xE3, 0x2E, 0xAE, 0x61, 0x3D, 0xA1, 0x7E, 0x47, 0x7C, 0xF3, 0x19, 0xE4, 0x61,
  0x68, 0xF6, 0x01, 0x5E, 0x2B, 0x37, 0x28, 0x8D, 0x88, 0xDE, 0xB2, 0x4A, 0xCD, 0xB3, 0xDF, 0x14,
  0x57, 0xDA, 0x31, 0xC1, 0x70, 0x43, 0xE0, 0x7D, 0xD4, 0x49, 0x60, 0x33, 0xBF, 0x0D, 0x15, 0xB5,
  0x18, 0x51, 0x59, 0x53, 0x58, 0xF3, 0x55, 0xC3, 0x9D, 0xB0, 0x87, 0x87, 0x62, 0x42, 0x86, 0x49,
  0xD3, 0x7E, 0x7D, 0x51, 0xFF, 0x9A, 0x5A, 0x1E, 0x91, 0x47, 0x5A, 0x3B, 0x65, 0x5B, 0x40, 0xD4,
  0x9A, 0x61, 0x3F, 0xFB, 0x3F, 0x40, 0x95, 0x28, 0x77, 0xD7, 0xB7, 0x9E, 0x5F, 0xEC, 0xC3, 0x04,
  0x5D, 0x4D, 0x10, 0xD3, 0xA7, 0x16, 0xE6, 0x0A, 0xFB, 0x2F, 0x07, 0x98, 0xFA, 0x3D, 0xCD, 0x35
  }
},
  { /* CRT Coefficient - pq*/
  0x18, 0xC2, 0x63, 0x25, 0x6E, 0x1C, 0xF0, 0xA2, 0xA2, 0x37, 0xB9, 0x2E, 0xE3, 0x96, 0x81, 0xB0,
  0x90, 0x85, 0x11, 0x49, 0xD9, 0xB6, 0xEA, 0xB4, 0x49, 0xEB, 0x56, 0x53, 0x34, 0x0B, 0x52, 0xF1,
  0x27, 0x95, 0x31, 0xAA, 0x36, 0x47, 0x7B, 0x84, 0x77, 0x52, 0x20, 0x0E, 0x57, 0x73, 0x05, 0x87,
  0x81, 0xA3, 0xA3, 0xA1, 0xCB, 0xA0, 0x20, 0xDA, 0xF5, 0xEC, 0xD2, 0x73, 0x2A, 0x88, 0x9C, 0x00,
  0x95, 0x38, 0xFA, 0x9E, 0x77, 0xAF, 0x7B, 0xE0, 0xF1, 0x06, 0x44, 0x8D, 0x3A, 0x88, 0x4C, 0x34,
  0x0D, 0x3D, 0xBD, 0x6A, 0x60, 0xBC, 0x03, 0x16, 0x31, 0xFC, 0xDF, 0x15, 0x7A, 0x0C, 0x83, 0x64,
  0x4E, 0xA5, 0xD9, 0xC4, 0x2A, 0x88, 0x36, 0xF1, 0x01, 0x7B, 0x78, 0x83, 0xDD, 0xBA, 0xE8, 0x89,
  0xD5, 0x59, 0xC8, 0xF3, 0x5D, 0x29, 0x7C, 0xF8, 0x7F, 0xD3, 0x8E, 0xB6, 0x4C, 0xDF, 0x14, 0x2C
  }
}
```

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A secure key system for completing a confirmation process, comprising:
a key provider for partitioning a private key into a plurality of key components, wherein each of said key components is converted by said key provider; and
a plurality of key holders storing said key components therein respectively for enhancing a security level of said private key, wherein all of said key holders are united to synthesize back said private key from said key components in order for completing said confirmation process so as to ensure said confirmation process being verified by all of said key holders.

2. The secure key system, as recited in claim 1, wherein each of said key holders is a transport card adapted for being held by an authorized person, wherein each of said transport cards stores said respective key component partitioned and converted by said key provider, in such a manner that all of said transport cards must be represented to unite and convert said key components for synthesizing said private key.

3. The secure key system, as recited in claim 2, wherein one of said transport cards is designated as a target card that said private key is synthesized at said target card.

4. The secure key system, as recited in claim 3, wherein said private key is synthesized at said target card for completing said confirmation process and said private key is immediately erased once said confirmation process is completed.

5. The secure key system, as recited in claim 1, wherein said key provider is a seed card to transitionally save said private key and to initialize said key components to be saved in said key holders respectively.

6. The secure key system, as recited in claim 4, wherein said key provider is a seed card to transitionally save said private key and to initialize said key components to be saved in said key holders respectively.

7. The secure key system, as recited in claim 1, wherein said key provider has a paired key of Application Public Key (AKp) and Application Private Key (AKs) being encrypted and converted into said key holders.

8. The secure key system, as recited in claim 6, wherein said key provider has a paired key of Application Public Key (AKp) and Application Private Key (AKs) being encrypted and converted into said key holders.

9. The secure key system, as recited in claim 1, wherein said key provider and said key holders are smart cards that each of said smart cards has a serial number and a set of Personal Identification Numbers (PIN), wherein said PIN has Personal Identification Number for Management (PINm) and Personal Identification Number for User (PINu), in such a manner that at least one of said PINm and PINu of each of said key holders is required to input in order to untie said key holders and to synthesize back said private key from said key components.

10. The secure key system, as recited in claim 8, wherein said key provider and said key holders are smart cards that each of said smart cards has a serial number and a set of Personal Identification Numbers (PIN), wherein said PIN has Personal Identification Number for Management (PINm) and Personal Identification Number for User (PINu), in such a manner that at least one of said PINm and PINu of each of said key holders is required to input in order to untie said key holders and to synthesize back said private key from said key components.

11. The secure key system, as recited in claim 1, wherein said key provider generates a random number for each conversion of said private key to said key components in such a manner that said key components are randomly exported to said key holders in responsive to said random number for prevent said key components from being duplicated.

12. The secure key system, as recited in claim 10, wherein said key provider generates a random number for each conversion of said private key to said key components in such a manner that said key components are randomly exported to said key holders in responsive to said random number for prevent said key components from being duplicated.

13. A key encryption method for completing a confirmation process, comprising the steps of:
(a) partitioning a private key into a plurality of key components;
(b) converting said key components;
(c) after said key components are converted, exporting said key components into a plurality of key holders respectively for enhancing a security level of said private key; and
(d) synthesizing back said private key by uniting said key components in said key holders in order for completing said confirmation process so as to ensure said confirmation process being verified by all of said key holders.

14. The method, as recited in claim 13, wherein the step (a) further comprises a step of selecting the number of said key components to be partitioned from said private key, wherein the number of said key components correspondingly matches with the number of said key holders.

15. The method as recited in claim 14 wherein, in the step (d), said private key is synthesized back at one of said key holders.

16. The method, as recited in claim 15, wherein each of said key holders is a transport card adapted for being held by an authorized person.

17. The method, as recited in claim 16, further comprising a step of selectively designating one of said transport cards as a target card that said private key is synthesized at said target card.

18. The method, as recited in claim 17, after the step (d), further comprising a step of erasing said private key synthesized in said target card after said confirmation process is completed, wherein all of said transport cards are reset back to their original settings of said key components.

19. The method, as recited in claim 13, wherein the step (b) further comprises a step of encrypting said key components after said key components are converted and before said key components are exported to said key holders respectively.

20. The method, as recited in claim 18, wherein the step (b) further comprises a step of encrypting said key components after said key components are converted and before said key components are exported to said key holders respectively.

21. The method, as recited in claim 13, wherein said key provider is a seed card to transitionally save said private key and to initialize said key components to be saved in said key holders respectively, wherein said key provider has a paired key of Application Public Key (AKp) and Application Private Key (AKs) being encrypted and converted into said key holders.

22. The method, as recited in claim 20, wherein said key provider is a seed card to transitionally save said private key and to initialize said key components to be saved in said key holders respectively, wherein said key provider has a paired key of Application Public Key (AKp) and Application Private Key (AKs) being encrypted and converted into said key holders.

23. The method, as recited in claim 13, wherein said key provider and said key holders are smart cards that each of said smart cards has a serial number and a set of Personal Identification Numbers (PIN), wherein said PIN has Personal Identification Number for Management (PINm) and Personal Identification Number for User (PINu), in such a manner that at least one of said PINm and PINu of each of said key holders is required to input in order to untie said key holders and to synthesize back said private key from said key components.

24. The method, as recited in claim 22, wherein said key provider and said key holders are smart cards that each of said smart cards has a serial number and a set of Personal Identification Numbers (PIN), wherein said PIN has Personal Identification Number for Management (PINm) and Personal Identification Number for User (PINu), in such a manner that at least one of said PINm and PINu of each of said key holders is required to input in order to untie said key holders and to synthesize back said private key from said key components.
